(19) United States
(12) Patent Application Publication
(10) Pub. No.: US 2008/0005024 A1
(43) Pub. Date: Jan. 3, 2008

(54) DOCUMENT AUTHENTICATION SYSTEM

(76) Inventor: Carter Kirkwood, Los Angeles, CA (US)

Correspondence Address: IRELL & MANELLA LLP, 1800 AVENUE OF THE STARS, SUITE 900, LOS ANGELES, CA, 90067, US

(21) Appl. No.: 11/750,178

(22) Filed: May 17, 2007

Related U.S. Application Data
(60) Provisional application No. 60/747,524, filed on May 17, 2006.

(51) Int. Cl. G06Q 40/00; H04L 9/00

(52) U.S. Cl. 705/50

(57) ABSTRACT

A document management system separates the rights and control of the author of a document, such as a financial institution reporting financial information to a client front the rights and control over the document contents of the owner of the document, such as the client of the financial institution whose information is being presented. In preferred embodiments, the document owner controls distribution of the document to desired users, such as a mortgage broker or a tax accountant, but without the ability to change the contents or at least without the ability to do so without the ability to make changes without detection. As a result, the author may provide the owner with a document that the owner can cause to be received by a desired user or other recipient while maintaining the authentication of the document by the issuing author, for example, the financial institution. The privacy and security of the data contents may be protected by encryption. In one embodiment, for example, the author may encrypt the document and the owner may select recipients to receive the decryption key, for example, via a website. Many alternate embodiments are described using techniques which produce similar results.

### CROSS REFERENCE TO RELATED APPLICATIONS

This application claims the priority of provisional U.S. application Ser. No. 60/747,524, filed May 17, 2006.

### BACKGROUND OF THE INVENTION

1. Field of the Invention

This invention is related to information access and distribution and in particular to techniques for the access and distribution of authenticated sensitive private data such as personal financial and medical information.

2. Background of the Invention

Physical mediums of communication (like ink on paper) are today the primary means by which information (including without limitation financial and medical information) is communicated, organized, and stored in our economy and society, especially for individuals and small businesses.

Despite the potential benefits of digital forms of communication there are several kinds of information (like medical records, tax records, work expenses, and financial information for getting a loan) that are still rarely communicated in a digital form. These kinds of information generally have shared characteristics which until now made it impractical to use digital means of communication. These shared characteristics include 1) the party that creates or generates the digital information is different from the Owner who controls the access rights to that information, 2) a privacy and/or confidentiality concern exists, and 3) the Document Recipient wants to be sure the information is delivered accurately to them despite having been in the possession of the Owner.

This application uses the term “Author” to include any party that creates or generates a particular Document. The term “Owner” includes any party that either i) has a privacy or confidentiality right in that particular document, or ii) for other reasons has the knowledge or right to be able to determine which Document Recipient to send a particular Document to. The term “Document Recipient” includes any party other than the Author or Owner of a particular document who receives that Document. The document is often but not always sent to the Owner who then forwards it to the Document Recipient. In some cases the Owner may grant permission to the Author to directly send the document to the Document Recipient. The term “document” includes any combination of two or more pieces of data that are combined in a single electronic file the contents of which are intelligible to people. Electronic documents may also have characteristics that correspond to characteristics of their paper counterparts such as specific fonts, point sizes and pagination. Many parties will from time to time play each of these roles with respect to different documents. For example an accountant at an accounting firm might act as a Author when he sends out a completed tax return to a client, be an Owner when he receives a receipt from a hotel during a business trip that he later submits on an expense report, and be a Document Recipient when he receives copies of 1099s from a client in order to be able to prepare a tax return.

The Author of the relevant financial or medical document often does not know the ultimate destination of the document (for example a bank would have no idea which accountant a taxpayer would forward a copy of their 1099 to) and may not have the right to send the information to a Document Recipient unless it has the clear approval of the Owner. Thus the information is normally sent to the Owner who then controls which among thousands of ultimate Document Recipients the information is sent to. In other cases (as when a consultant incurs expenses and only he or she knows which of his or her clients they are attributable to) the privacy right may be weak or nonexistent but only the Owner knows who it is appropriate to send the information to. In both cases the Owner (but not the Author) decides and controls who sees and has access to the information. The Owner often either wants or has an obligation to make sure that only certain Document Recipients are able to see the information and that the information is not available to the general public or computer hackers.

Furthermore, accuracy is important to the eventual Document Recipient and they often want verification that the information has not been altered either accidentally or intentionally by the Owner or others. This is especially true when the Owner might have a motive to alter a document in their possession (for example overstating business expenses, or overstating income for a loan application, or understating income for tax purposes).

Thus, the Author and the Owner of the Document are often two different entities, whereas most electronic document systems assume that these two entities are always one and the same or else ignore the possible difference. The Document Author may be assumed to be the natural Owner of the document contents by those systems, however in many cases in the real world this is simply not the case. A bank customer or doctor's patient is naturally the Owner of their own information, even though a separate institution or professional authored the document in question.

Enterprise Document management systems have been developed for large organizations. Typically a Document management system electronically stores in a common database hundreds of thousands (often millions) of documents including both scanned images of paper documents and digital or electronic documents (which can be in multiple formats). This saves on the cost of storing and reproducing documents. These systems often index these documents so that users can quickly and accurately search for documents based on various search criteria. This reduces the time and cost spent searching for documents (including those that have been misfiled) and replacing documents that cannot be found. These systems often allow multiple users to share a single copy of a document and to take turns accessing a document (thus allowing the quick distribution of documents). Some of these systems also use structured content concepts to allow the automatic reuse of certain information contained within the documents. This may reduce the cost of extracting and reentering information to be used in subsequent information systems. In order to protect the confidentiality of the documents, users may have to log into the systems using a user ID and password provided and monitored by the organization. These systems typically record and log who accessed, modified or deleted any file in the system and track multiple versions of documents (thus creating an audit trail for proving authenticity).

However, the techniques and system architecture used to provide these functions are typically based on three distinctive dynamics of large organizations. First, the enterprise systems are usually centrally administered and controlled and typically can only be accessed by employees and a few trusted outside parties. Second, enterprise systems typically include hundreds of thousands (or millions) of records. This means that any upfront costs (purchase and installation of hardware and software and training of staff) in time or money can be offset by cost and time savings spread over that multitude of Documents. Furthermore, the large volume of documents means that the indexing system has to be able to find just one or two relevant documents out of hundreds of thousands of possible documents. Third, large organizations also typically have specially trained staff that a) manage information technology systems for them, and b) run their recordkeeping process.

However, because those systems are designed for large organizations, the techniques and system architecture that are used to provide these functions fundamentally are unwieldy for use by individuals or small businesses. For example, these systems do not address the situation where one party (the Author) creates a document but another party (the Owner) has certain legal rights in the Document (like privacy rights). This often occurs with financial and medical records. These systems also do not reduce an individual's up front costs by providing documents with metadata predefined. These systems require Owners and Document Recipients to use a different process to access a document, check its authenticity or verify its contents for each Author that is part of a different enterprise's rights management system and they have to become a registered user on each of those systems. The use of these systems also means that the system administrator has access to all of the documents (and their contents) and to the security protocols for protecting those documents, so the system administrator potentially has access to all of the information.

What is needed is a document authenticating system which does not have the drawbacks of known systems.

### SUMMARY OF THE INVENTION

In a first aspect a method of providing financial documents is disclosed including the steps of obtaining an encrypted financial document related to a financial services user from a source of financial services, forwarding—to a escrow key server—one or more encryption keys for decrypting the encrypted financial document, facilitating the transfer of the encrypted financial document to a financial document user as authorized by the financial service user and transferring a copy of the one or more encryption keys from the escrow key server to the financial document user as authorized by the financial service user so that the financial document user can decrypt the encrypted financial document as an authenticated document unchanged from when it was obtained from the source of financial services.

The transfer of the encrypted document to the financial document user may include receiving a request for the encrypted document at the escrow key server from the financial document user; obtaining approval from the financial services user to transfer the encrypted financial document to the financial document user; and then transferring the encrypted financial document to the financial document user. The encrypted document and one or more encryption keys are transferred together to the financial document user. Facilitating the transfer of the encrypted document to the financial document user may include receiving authorization from the financial services user for the key escrow server to transfer the encrypted financial document to the financial document user upon request and forwarding the encrypted financial document from the escrow key server to the financial document user upon receipt of a request therefore from the financial document user. A copy of the encrypted financial document may also be forwarded to the financial services user who may forward the encrypted document to the document user.

### BRIEF DESCRIPTION OF THE DRAWINGS

FIG. 1 is a block diagram illustration of a documentation authentication system which may provide separate paths between an encrypted document source and the encryption key.

FIG. 2 is a block diagram illustrating an alternate embodiment of the system shown in FIG. 1 in which a pre-generated blank intelligent document is used.

FIG. 3 is a block diagram of an alternate embodiment in which document viewing software may be provided with the transmitted document.

FIG. 4 is a block diagram illustrating an alternate embodiment in which a centralized directory may be provided in an escrow server.

FIG. 5 is a block diagram illustrating an alternate embodiment in which successive public key encryptions and partial decryptions may be daisy chained for proof of authenticity.

FIG. 6 is a block diagram illustrating an embodiment using a central look up repository for public keys of entities in the system.

FIG. 7 is a block diagram of an embodiment in which the author may encrypt a document with the recipients public key directly.

FIG. 8 illustrates another embodiment which allows the owner to control access rights to the document while ensuring that the document has not been tampered with.

FIG. 9 illustrates an alternative embodiment where recipients may receive the encrypted document directly after the owner grants permission for the transfer to occur.

FIG. 10 illustrates an embodiment in which the key server may be distributed rather than centralized.

FIG. 11 illustrates an embodiment in which the owner may be able to automatically crawl a number of information servers to acquire relevant documents in addition to receiving documents passively in order to manage, store and index documents, data, and metadata from multiple sources as well as manage the delivery of these items to multiple recipients from a single interface.

FIG. 12 illustrates an embodiment in which the owner may send an encrypted document to an unknown recipient and have that recipient be able to open and view that encrypted document.

FIG. 13 illustrates an embodiment in which one-time pads are used as the primary encryption mechanism between participants in the system.

### DETAILED DESCRIPTION OF PREFERRED EMBODIMENT(S)

Before describing the preferred embodiments in detail, it is believed to be useful to describe the related aspects of conventional systems. The following descriptions are not held out as accurate descriptions of particular systems but are rather used herein to provide a context for the understanding of the inventive method and apparatus for providing authenticated documents to be described in greater detail below.

Classic peer-to-peer network systems may include files stored on peer machines and transferred directly from one peer machine to another. They may include a centralized real-time index of all files on all peer machines in the network at any given moment. Anytime a file request is made by a peer machine, the central directory may give the IP address of another peer machine which currently has a copy of that file, and a transfer of that file may then be made from the second machine to the first. Certain data about the files in the network may be stored on the centralized directory, while the actual files may not be stored there. This arrangement may facilitate the quick finding and distribution of files.

There are peer-to-peer systems, such as Red Swoosh or Kontiki, which may provide authenticated file distribution mechanisms. Such systems may store a copy of the file centrally (e.g. as a master reference or gold standard against which to compare files moving between peers to try to ascertain whether they have been tampered with, that is, whether or not the files are authentic as unmodified originals. In such systems, the file's Author may solely control which peers in the system are able to receive and open the file. Typically, these systems may be used for distribution of large copyrighted files, such as audio files and movies. The file's Owner may, for example, use this access control to make certain only paying customers are able to access the file.

However, such peer to peer systems may be designed to make content available to anyone who uses the system (or at least anyone who is willing to pay for access to a particular file). Also to protect the Author's copyright rights, peer to peer client software must often be downloaded and run before a file can be received. Thus, peer-to-peer systems may not allow new Document Recipients to receive files before they are members of the peer network. These systems may not address the situation where the Author of a document is not the Owner. In particular, there appears to be no convenient capability for division of rights between multiple entities and indeed this capability is contra to the very purpose of the Author-friendly digital rights management controls these systems seem to seek to create.

Some document technologies currently in the market (such as Adobe Intelligent Document and Adobe LiveCycle systems) appear to try to combine the look of a paper document with the advantages of an electronic document. PDF/XML forms seem to look like a printable paper document, the fields within it are said to be editable from within a browser or viewer. Such forms may also provide error-correction and auto-formatting (i.e. social security numbers are displayed as NNN-NN-NNNN).

The XML data tagging language makes it easy for computers to extract data from documents for automatic reuse by other software. Existing XML languages may provide a common dictionary that allows information to be cheaply and quickly “read” (or extracted) by a computer program other than the original creating program and then entered into the proper data fields (with a reduced risk of data entry errors). There are many various types of XML languages such as Open Financial Exchange's XML and the Internal Revenue Services' IR XML.

However, these types of technology typically uses public key encryption or a password to protect the privacy of the information contained within documents managed by the system. Public key encryption typically requires that the encrypting entity encode a document using the intended recipient's public key, and therefore the recipient must be identified beforehand. Likewise, with a password-protected document, the Author must provide the password to the recipient, and so the Author must know who the Document Recipient is. Such systems do not appear to be able to use such encryption and then securely distribute an authenticated document to a Document Recipient that is obscured or unknown to the Author or his or her enterprise.

Thus systems like the Adobe system appear to require that Owners and Document Recipients use a different process to access a document, check its authenticity or verify its contents for each Author that is part of a different enterprise's rights management system and Owners and Document Recipients have to become registered users on each of those systems. These systems also apparently require that the system administrator has access to all of the documents (and their contents) and to the security protocols for protecting those documents, so the system administrator potentially has access all of the information.

In such systems, there appear to be two methods that an Author can use to provide access to a document: the first is password-based, and the second is public-key encryption based, coupled with a digital certificate check and an embedded hash check. In both of these methods, the Author may be assumed to be the Document Owner. The Author may designate certain Document rights (such as read, alter, print, etc.) to a Recipient by associating a given password with these rights and then giving this password to the Recipient via an alternative path (such as phone, email, etc.). Alternatively, the Author may assign certain document rights to a Recipient based on their identity as confirmed by a digital certificate. The Author may also dynamically rescind these rights based on the Recipient's digital certificate-based identity.

However, there appears to be no concept of a remote Document Owner being someone other than the Author, nor does there appear to be a key escrow server which dynamically distributes decryption keys after the creation of a document. The Recipient must apparently be a known entity to the Author for this type of system to function.

As a result, to the extent that an Owner or Document Recipient is not a registered user in the Author's document rights management system, then this type of system does not provide 1) a means for documents to be automatically and systematically distributed from multiple Authors to multiple Owners or to multiple Document Recipients; or 2) Document indexing.

A system called Open Financial Exchange's XML is used to transmit data from banks and other financial institutions to Quicken, QuickBooks, TurboTax, Money and other programs that comply with Open Financial Exchange's requirements (“OFX Compliant Programs”) where the programs then process the information and turn it into a format that can be displayed in proprietary formats. OFX Compliant Programs can apparently automate the process of gathering data from multiple sources. For example, they apparently can gather a particular person's financial information from multiple credit card companies, banks, brokerages, and mutual funds at one time (once the appropriate user identification and password information is entered into the program).

However, this type of system appears to be fundamentally data-centric, rather than document-centric. Thus, each bit of data can be manipulated, distributed, and stored independently of any other data. Furthermore, these programs do not appear to display the information in a manner that looks substantially like the related paper document that normally contains the same information. Because the information in the documents is transmitted, but the document itself is not, the specified formatting, fonts, pagination, etc. may be lost. Furthermore, these programs do not provide authentication or verification to third parties. Nor do these systems appear to provide a place where a Document Owner can manage the rights of all their documents from multiple Authors. Also, once downloaded into one of the OFX Compliant type of programs, there is also no apparent integrated way to forward this information in a secure or protected manner. Such systems do not provide a central server for ongoing document rights management.

Other financial institutions, such as Charles Schwab, have introduced systems in which independent investment advisors with a legal relationship with the institution are allowed to download digital copies of monthly statements and allow the independent investment advisors to archive these documents by master account number. These systems are proprietary and can only be used by Document Recipients with whom the institution has a direct legal relationship. Other institutions offer a “Manage Users” function that allows clients to set up user identification numbers and passwords for multiple Document Recipients other than the client, which allows the Document Recipients to view and download any information related to a particular account.

In such systems, the users that are provided access get access to all information related to a particular account, not just to particular documents. These systems appear to be proprietary to specific financial institutions. Furthermore, after a document has been downloaded there is no persistent ability to verify the authenticity or verify the accuracy of the document.

The embodiments disclosed provide systems which provides one or more of the following functions and features: 1) dynamic distribution of decrypt keys; 2) a way to send an encrypted document to someone who does not have a public key (or when the sender does not know the public key) and to later provide access to the document after the identity of the recipient has been verified; 3) a way for the Author of a document to designate the Owner of that document so that the Owner can control access to the document; 4) a way for the Owner to control access to a document without needing access to the Author's rights management system; 5) a single control panel that an Owner can use to control its rights in documents from multiple Authors; 6) a way for the Owner to verify the identity of a particular Document Recipient to make certain that only the intended Document Recipient get access to the file; 7) persistent control over index information, information reuse, privacy, or authentication; 8) a way for different third parties to be able to control different rights in the document; 9) authentication that can be confirmed by third parties unknown to the Author; 10) a non-encrypted way to identify the Author of a Document to facilitate the quick identification of the proper public key to use to open an encrypted Document from an Author that is unknown to the Document Recipient; and 11) allow third parties using only one system to authenticate or verify the accuracy of multiple documents from multiple Authors who are part of different enterprises.

The preferred embodiments provide for the creation of a distributed document management system for individuals and small businesses with all or several of the attributes described above and would make it easier for individuals and small businesses to gain from the benefits of a transition to a digital information system from a paper based information system using centralized document management where documents are not stored centrally and where permissions and workflow are distributed appropriately.

The disclosed systems generally provide five core functions. They can operate independently of each other or any combination of the five core functions can be used together. Some require the Author to take certain steps to provide full functionality. Others can be initiated by the Owner at least to some degree. First, there is the auto download function, second there is the archive function, third there is the extractable data function, fourth there is the privacy function, and fifth there is the authentication and verification function.

In particular at least some of the embodiments of the disclosed invention provide: 1) a means for documents to be automatically and systematically distributed from multiple authors to multiple owners and to multiple Document Recipients; 2) a separate pathway for an encryption key to travel than the document; 3) a way to send an encrypted document to someone who does not have a public key (or when the sender does not know the public key) and to later provide access to the document after the identify of the recipient has been verified; 4) a way for the author of a document to designate the owner of that document so that the owner can control access to the document; 5) a way for the owner to control access to a document without needing access to the author's enterprise rights management system; 6) a single control panel that an owner can use to control his or her rights in documents from multiple Authors; 7) a way for the owner to verify the identity of a particular Document Recipient to make certain that only the intended Document Recipient gets access to the file; 8) persistent control over index information, information reuse, privacy, or authentication; 9) a way for one or more parties other than the author to be able to control different rights in the document; 10) authentication that can be confirmed by Document Recipients unknown to the author; 11) a non-encrypted way to identify the Author of a document to facilitate the quick identification of the proper public key to use to open an encrypted document from an author that is unknown to a Document Recipient; and 12) third parties with a single system they can use to authenticate or verify the accuracy of multiple documents from multiple Authors who are part of different enterprises.

The Auto Download function allows an Owner or a Document Recipient to enter document location information (typically a URL but this could also be LDAP-based or employ any other network resource locator protocol) and access control information (typically a user ID and Password, but this could also be an encryption key) one time into a software program where it is then stored locally. The program can store this information about more than one source of documents, thus allowing the program to gather documents from multiple Authors in one process. The software program can reside on any computer although it typically will either reside on the Owner's or Document Recipient's personal computer or it can reside on an online server. This information can then be used to repeatedly access and download documents stored on a computer that may be accessible over the Internet without the Owner or Document Recipient needing to retype the contact information or access control information again. This function makes it easier and quicker to gather and download digital copies of documents from one or more Authors. In the event that a particular document has been previously downloaded and an updated version is available from the remote location, the updated version may be downloaded and replaces the older version.

In order for this function to be optimized for speed, efficiency and ease of use, the Author or Owner can define and employ system rules for how and when documents are downloaded. For example there can be a rule by which documents that have been downloaded previously by a particular party are identified and not downloaded again. The software program used by the Owner or Document Recipient may then use a complimentary procedure to find the relevant documents on the Author's computer and to only download the relevant documents. There may also be a rule to download a new copy of a document if it has been altered since the last download, or only to download fragmentary updates or deltas to a document as needed.

The archive function may automatically index copies of these documents on any storage device used by an Owner or a Document Recipient to store related documents. This may provide the ability to 1) easily perform searches on their content or associated metadata, 2) perform version control, and 3) provide for easy document retrieval and display. The archive function may add additional information including metadata to a document for local indexing and other purposes. It may also keep a historical record of every action it has performed on every document and allow a user to perform history audits and backtrack to previous versions and system states.

By way of example only, a financial institution would typically know a customer's name, his or her social security number, the account number, the type of account (for example checking, saving, brokerage, mutual fund), relevant dates (for example the date the document was created, downloaded, the tax year for the document) for a particular document, the type of institution the Author is (for example banking, brokerage, insurance, accountant), the type of document (for example a monthly statement, a 1099, a 1098, an annual report, a prospectus) it is sending.

The disclosed system could then allow the Author to associate that metadata to either documents received digital or scanned from a physical document using a standardized format and language. The Owner's and Document Recipient's software programs would be able to identify that information and use it to automatically organize, file, index, sort, retrieve, copy, forward each particular document according to its metadata.

Alternatively, the disclosed system could allow Owner's software to run a word or number search of a document looking for certain words or numbers like the name of a particular Author (like Wells Fargo, Wachovia, Vanguard, or Charles Schwab), or particular account numbers, or document descriptions (like Monthly Statement, Trade Confirmation, W2, 1099, etc). The disclosed system could be able to use these searches to identify how to index a particular document and attach appropriate metadata to each document.

Once the documents are indexed, a consumer's software program could be able to organize all of the documents he or she received from one or more financial institutions by account numbers, names of the financial institutions, dates of the documents, types of documents, types of financial institutions. The disclosed system could for example be able to find all 1099, W2, 1098, K2 tax Documents for a particular tax year. Those documents could then collectively be copied and forwarded to that consumer's accountant for preparation of their tax return.

To the extent that the Author of a particular electronic document did not attach metadata that a particular Owner or Document Recipient would find useful to organize particular documents, or the Owner's software was not able to find particular numbers or words when a search was run, then the disclosed system could allow either the Owner or the Document Recipient to add additional metadata manually. If the Owner adds metadata to a document that is subsequently sent to a particular Document Recipient, then that Document Recipient will be able to use the metadata provided by the Owner in addition to any metadata provided by the Author to organize the documents.

The disclosed system may also allow parties other than the Author to be able to control whether particular recipients of a particular document can have access to the metadata about a particular document. So, for example, a consumer may elect to not allow access to social security metadata to a particular mortgage broker while allowing access to that same metadata to their accountant. As another example, the provider of the disclosed system may not allow access to a particular Document Recipient or all or parts of the metadata information about a particular document, until a fee has been paid by that Document Recipient to the provider of the disclosed system.

The add-on or metadata that the Author may attach may include specific kinds of metadata related to the document they create. This add-on or metadata may be chosen because it is already known to the Author (and other Authors will know this about their own documents) and the information will be useful to Owners and Document Recipients in indexing the documents they receive from multiple Authors. The use of this system allows documents to flow across a decentralized disorganized network of individuals and to be easily and automatically sorted, combined, filed, tracked, and analyzed by numerous Owners and Document Recipients who can not directly coordinate their efforts. It allows people to have the benefits of a centralized coordinated information organization scheme without needing to create it or agree with one another about how it works.

The disclosed system may include field-specific metadata functionality, that is extractable contextual data. More specifically the disclosed system may allow Authors to attach or include extractable contextual data in the documents provided by the Author. An example of metadata formats includes the various extensible markup languages (or XML). By way of example only, in the case of tax documents, the IRS' XML can be used or open financial exchanges XML can be used. Other XML formats can be used as appropriate.

When extractable contextual data is included in or attached to a particular document that allows a software program other than the Authors to be able to quickly and easily identify and extract the relevant information for that software program from that particular document. By way of example only, it could allow the software program for a mortgage lender to very quickly extract the asset and debt values from several documents that come from different financial institutions that belong to one person and then to calculate the combined net worth that this individual has in those accounts.

Field-specific metadata such as that provided by XML may be useful for providing machine-ready documents. In the disclosed system, data contained in fields within documents so prepared can be easily transferred to other internal systems and databases seamlessly without the need for manual re-entry.

The disclosed system may provide a method by which an unknown third party may receive an encrypted document and have a means to initialize an account with the system and in so doing, access the document without previously having generated a public/private key pair.

The Author or Owner then encrypts a document again using a regular encryption key (not public key encryption). Anyone with this particular key may decrypt the document, including parties other than the intended recipient. The document is then wrapped in executable software, and the package is then sent to the third party.

When the third party receives the document packaged as an executable and attempts to open it, the software runs and informs the third party that it will need to first register with the disclosed system and download system client software, and provides a way for them to do so. Once they have registered and downloaded the software, the system generates a public/private key pair for the third party and sends it to them (alternatively, the system software generates it locally).

The Owner may then be informed that the third party wishes to access the original document. The Owner can then grant or deny access. If they choose to grant access, the original document key may then be sent to the third party via a secure communication using the third party's just-generated public/private key pair, allowing the third party to immediately open the document, without requiring that it be encrypted with the third party's public key and re-sent.

This method can also be used to provide authentication if the Author encrypts a document using the public key of the Owner. The document can then be sent to the Owner. The Owner decrypts the document with his or her own private key, while leaving the digital signature of the Author intact. The Owner may only view the document but not alter it. The Owner then follows the steps described above.

The first embodiment provides the disclosed functions with a pre-encrypted document that they can be received and forwarded by an Owner through a number of electronic or digital methods from numerous Authors to numerous Document Recipients. This technique involves multiple layers or types of encryption and multiple encryption keys. Some keys control access to all or parts of the entire data file including metadata, other keys control particular kinds of functionality like validation.

Once a document is put in the encryption envelope by the Document's Author, the encryption keys may be sent to a encryption key server (which can be run either by the Author or by a third party acting in the manner of an escrow agent) where the Owner may get indirect control over some or all of those keys, but not the encryption keys for validation. The provider of the encryption key server, e.g. an escrow agent, never needs to have access to the underlying documents or information.

While this system may appear to be very similar to a corporate document management system, a key difference is that it allows documents to be distributed like a classic peer-to-peer network as opposed to a centralized system. In the disclosed system, access to files is not controlled at all: they may be emailed, transferred via FTP or HTTP, copied, stored or deleted. However, the ability to open or modify the file is centrally managed.

While the documents themselves may move across the open internet (or any network) freely, the permissions or encryption keys associated with that file may not travel with them. Instead, the keys may reside with a centralized encryption key server that acts much like a file location directory does in a peer-to-peer network. The encryption key escrow server confirms the identity of a requesting entity to perform some operation on the file, and based on permissions granted by the Author or Owner, the keys are either granted or denied.

The identity of a requesting entity is typically confirmed though usage of public key encryption protocols such as PGP. A key Authority would generally previously confirm the identity of the key holder as being a certain entity, such as a particular corporation.

A second embodiment involves an empty form program that generates multiple copies of blank forms each with its own set of multiple layers or types of encryption and multiple encryption keys. In this embodiment, this process makes the person who generates the blank documents the Author of the document. That Author is then able to send these encryption keys to an encryption key server that operates in a similar manner to that described in the first or other embodiments.

The multiple copies of the blank forms may then be sent to another program that inserts information into those blank forms. It is that program that then acts as the Author of the information but not necessarily as the Author of the document. The document can then be sent to the Owner or Document Recipient who has the same abilities as described in other embodiments.

A second embodiment may allow the Author to embed flags describing the functional controls permitted for a Recipient into the document itself. In this embodiment, operations performable upon the document are protected in a way similar to a digital rights management (DRM) system. For example, in iTunes, a user may download songs and play them, but the user may not copy them to unauthorized devices, forward them to other users, or modify them in any way.

In the same way, a document in the disclosed system may be encapsulated by the Author is such a way that the rights assigned to intermediaries are specified in the file format of the encapsulated document. When an Owner receives the document, the owner may only be able to open and view the document but not edit it. Alternatively, the owner may be able to view the document, and alter some fields, but not all fields. This may be accomplished by software on the Owner's system reading the encapsulated document and determining what rights are and are not applicable, and permitting actions as appropriate. As with iTunes, the encapsulated document is encrypted and obfuscated such that it is extremely difficult or impossible to parse it meaningfully without the system software.

Alternatively, the document may be encapsulated by the viewing software itself. In this embodiment, the viewing software may not previously have been installed on the Owner's machine; rather it may travel with the document. The viewing software may be prepared by the Author with the appropriate rights built into it directly. When an Owner receives this file from the Author, it is executed rather than read. The executable software then directly provides the ability to read the document according to the rights built into it by the Author.

A third embodiment involves sending the metadata or other add-on information, authentication and verification information (but not the actual document or the XML data) to an online escrow. The third embodiment provides a method by which a centralized directory acts as an escrow for all document metadata, add-on data, access and verification information.

In this method, the Author may first generate a document and encrypt it. A key for this document may then be deposited with a centralized online escrow server. Metadata and Author verification information may also deposited along with the key. The actual document itself, however, is not deposited.

The Author may then send the encrypted document to the Owner. The Owner is the sole entity with control over granting access rights to the document, and as such, may request the deposited key and access the document. However, the Owner may not alter the document.

The Owner may then forward the original encrypted document to a third party. The Owner may also grant access rights to this third party by using a software interface to the centralized escrow server or a web browser interface. The third party then receives the encrypted document. Software on the third party system may then request the key for the document from the escrow server. If access has been granted by the Owner, the key may then be sent to the third party who can then unlock the document. The third party is able to query the escrow server to determine who originally authored it for purposes of validating that it is an authentic and unaltered by the Owner.

Alternatively, the escrow server may store a hash, or other altered form, of the original document. The Author initially generates a hash table or the like based on the contents of the document. This hash table may then be deposited with the escrow server. The third party Document Recipient's software may then perform an integrity check on the file using the hash table stored with the escrow server to determine whether the Owner has altered it.

A fourth embodiment involves a partial decrypt and save process. The fourth embodiment provides a method whereby the Author encrypts a document using a standard public key encryption technique such as PGP. In this embodiment, a centralized or distributed key escrow Authority is not required; rather a daisy-chain of successive public key encryptions and decryptions is used to achieve a similar effect, preserving permissions and providing authentication of the Author.

The Author uses the public key from the Owner and its own private key to encrypt the document. When the Owner receives the document, the owner makes a local copy of the document and decrypt this only with their private key, leaving the Author's private key signature intact. This makes the document readable to the owner who may inspect it for purposes of accuracy, etc. The Owner then encrypts the original document with the public key of the target third party Document Recipient. Then, the Owner forwards it. The third party Document Recipient may then decrypt the document with the public key of the Owner. This allows the Document Recipient to now see the document. However, the document is still signed with the private key of the Author, so the third party can use the Author's public key to verify that the document indeed originated with them and has not been tampered with. Through use of successive encryptions, the document is passed along from Author to Owner to Document Recipient in an encrypted, obscured fashion. This ensures that if the document is intercepted on the open internet through a packet sniffer or equivalent, it would remain inscrutable.

Alternately, the Owner and the third party Document Recipients may both deposit their public keys with a centralized registry of users of the system. This registry may validate the real-world identity of participants in the system and their associated public keys offline.

Alternately, the Owner may first request the third party Document Recipient's public key. The Document Recipient sends it to the Owner. The Owner then forwards the third party Document Recipients' public key to the Author. The Author then encrypts the document using this key, and sends the resultant file to the Owner. In this embodiment, the Owner may not view or inspect the document; it remains obfuscated to them while in their possession. The Owner then sends the document to the third party Document Recipient who then uses their private key to decrypt the document and view it.

A fifth embodiment involves the Document Recipient verifying the hash along with certain information about the Owner with the Author. In the fifth embodiment, the Author generates a hash based on the contents of the document. This hash is then embedded directly into the file. The file is then sent to the Owner. The Owner may now view the file and may even alter it. However, if the Owner alters or tampers with the file in any way, the hash table will be invalidated. The Owner forwards the file on to the third party Document Recipient. The third party Document Recipient's software then performs an integrity check on the file using the hash table to determine whether the Owner has altered it.

Alternatively, the hash may be stored with an escrow server when the Author creates the document. The Author then sends the document to the Owner, who in turn forwards the document to a third party Recipient. When the Recipient opens the document, the hash for that document is requested from the escrow server. It is then compared against the document to see whether it has been altered by the Owner or other party while in transit. In another embodiment of this method, the full document file itself is stored with the escrow server instead of just a hash, and a bit-compare is performed by the Recipient with the escrowed copy to ensure that it is the same file.

A sixth embodiment involves direct verification of the information by the Document Recipient with the Author. The sixth embodiment provides a method for the Document Recipient to obtain a document directly from the Author after the Owner has granted permission, rather than having the Owner pass it along.

In this embodiment, the Author acts as the distributor of the document. The Owner grants permission electronically for the Author to send the document, which it does. In one alternative, the document is encrypted by the Author with the third party's public key, and the third party simply uses their own private key to decrypt it. In another alternative, the document is transferred to the third party via a secure socket connection.

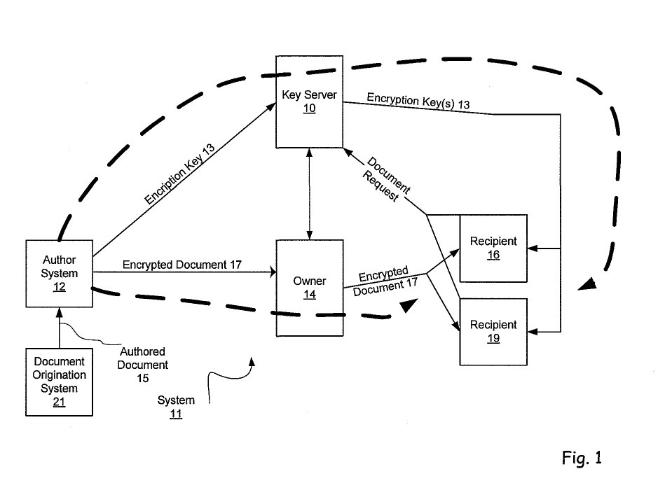

Referring now to FIG. 1, in operation, system 11 provides separate paths between an encrypted document source, such as author system 12, and/or document origination system 21, and the final user such as recipients 16 and 19, for encrypted document 17 and encryption key(s) 13. In particular, document path 23 from source to user includes owner 14 as an intermediary gatekeeper which protects the privacy of document 15 because, in this embodiment, encrypted document 17 is only available to owner 14 and to those potential users to whom document owner 14 chooses to provide encrypted document 17. Encryption key path 25 from source to user includes key server 10 as an intermediary gatekeeper which further protects the privacy of document 17 because the user cannot access encrypted document 17 without first obtaining permission (which may be granted ahead of time) from owner 14 permitting key server 10 to forward encryption key(s) 13.

It is important to note that the use of dual paths 23 and 25 permit key server 10 to be a source of verification for the user, e.g. recipient 16 or a final user not shown, that encrypted document 17 has not been altered after it was forwarded by author system 12. One mechanism for providing this verification may be the use of encryption key(s) 13 which are based on the bitwise content of encrypted document 17. For example, encryption key(s) 13 may be generated by author system 12 using a mechanism that creates a key dependent on the content of encrypted document 17, or in some circumstances authored document 15. That is, encryption key(s) 13 could be generated as a function of the value and location of each bit, or other unit of the document, and some other function. In this situation, encryption key(s) 13 would successfully decrypt encrypted document 17 if and only if document 17 had not been changed between the time of the creation of key(s) 13 and their use. A combination of public and private keys may be used for this purpose and other techniques may also be used.

Another useful feature of system 11 may result from the use of a standardized methodology for the creation of authored document 15. One of more sections or fields of authored document 15 may have a standardized meaning so that data can automatically be extracted by the user from the document once decrypted. For example, financial data may be organized by a standard, such as one adopted by the Internal Revenue Service (IRS) or one adopted by commercial services such as the Open Financial Exchange (OFE or OFX) developed by Intuit and others. The user, such as the IRS or a mortgage lender, would then be able to automatically extract specific data, such as an individual's net worth, by extracting the relevant data in accordance with the standard.

The following is an example of one possible use of system 11 in which the source may be a financial enterprise in which the operator of owner 14 maintains accounts and users may include a professional tax preparer and/or a mortgage company or other agency considering providing a loan to the operator. In this example, documentation system 21 may be the internal data system for a stock brokerage and author system 12 may be an encryption engine provided by the source or key server 10. The source may electronically provide account status information to owner 14 on a periodic basis and, at the same time, forward encryption key(s) 13 to key server 10. Owner 14 includes processing software which may permit the operator to view but not edit the account status information except, as noted above. In a simple case, such processing software may obtain key(s) 13 from key server 10 in order to view and extract but not edit data in encrypted document 17.

Owner 14 may then electronically provide encrypted document 17 on a periodic basis to recipient 16 who prepares tax forms for the operator to complete document path 23. In light of the ongoing relationship between the operator and the user, owner 14 may electronically indicate to key server 10 that permission has been granted to recipient 16 on an ongoing basis. Recipient 16 may then contact key server 10 to obtain key(s) 13 to view and/or extract data from encrypted document 17 which completes encryption key path 25.

The use of the encrypted dual path including key server 10 as a gatekeeper provides verification of the data to recipient 16, and others to whom recipient 16 forwards encrypted document 17, such as the IRS, without exposing the private data of the operator of owner 14 to key server 10. The use of the encrypted dual path including owner 14 as a gatekeeper permits owner 14 to limit the distribution of private data without raising concerns about the accuracy of the data (at least as provided by author system 12) to the user because the user will not obtain access to the data via encryption key(s) 13 if owner 14 has modified the data. Still further, the use of standardized formats for the data may permit automatic extraction of the data at least by the user. Extraction of the data by owner 14 may require the use of additional software provided by key server 10 with or without charge.

Owner 14 may also forward encrypted document 17 to recipient 19 which may be a mortgage company from whom the operator has requested a mortgage. When recipient 19 requests and receives encryption key(s) 13 from key server 10, recipient 19 has also obtained a verification that the data has not been altered after it was provided by author system 21.

Recipients 16 and 19 may have document reader software which, upon an attempt to open encrypted document 17, may perform an identity check on recipients 16 and 19 by way of a digital certificate or password or any other way of confirming identity. Once identity is confirmed, the document reader software then confirms whether that identity has rights associated with encrypted document 17, such as open, read, write, etc. This confirmation may be performed by checking with key server 10 (or some other third party) for rights granted by owner 14 to recipients 16 and 19, or these rights may be embedded in the document or conveyed in some other way. If and only if these conditions have been met, the document is decrypted, open and read within the confines of the document reader software. If recipients 16 and 19 forward encrypted document 17 to an unauthorized third party, this third party will find themselves unable to open the document. Thus owner 14 retains persistent control over encrypted document 17, regardless of where it is located, whether it has been copied, forwarded, etc.

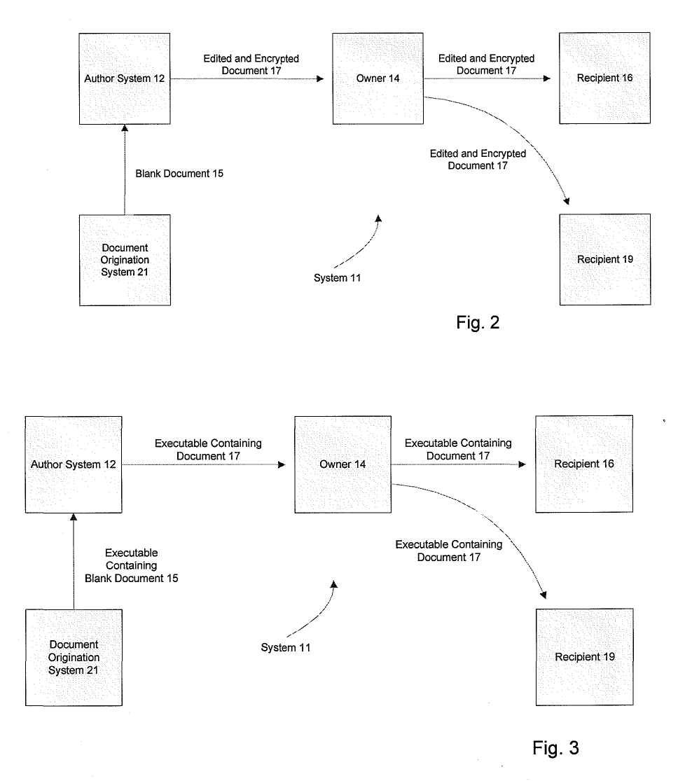

Referring now to FIG. 2, system 11 provides a way for pre-generated blank intelligent documents 15 to be fed to author 12 while preserving the control of owner 14 over the document, and assuring recipients 16 and 19 that author 12 is indeed the originating entity.

Document origination system 21 feeds blank documents or forms 15 to author system 12. The specific privacy and authoring rights in blank documents 15 granted to author system 12, owner 14 and recipients 16 and 19 are pre-defined by document origination system 21 and embedded in blank documents 15. Author system 12 can then open blank documents 15 and add data to the various form fields contained therein, creating edited and encrypted document 17. Author system 12 then forwards edited and encrypted document 17 to owner 14. Alternatively, owner 14 may pull encrypted document 17 from author system 12. Owner 14 may then either view and/or modify the previously edited and encrypted document 17, depending on the rights previously granted to owner 14 by document origination system 21. These rights may be granted on a field-basis or may apply to the entire document. Once finished, owner 14 may forward document 17 to recipients 16 and 19, who in turn may either view and/or modify document 17 depending on rights previously granted to recipients 16 and 19 respectively by document origination system 21. Alternatively, recipients 16 and 19 may receive document 17 directly from author system 12, or recipients 16 and 19 may pull document 17 directly from author system 12.

Document 17 may contain indexing information encapsulated directly into the document file itself rather than being remotely indexed by a centralized system. This indexing information may be a filing number, document name, date of creation, identity of the author, or any other information pertaining to the document. It may exist inside the encrypted document, or it may remain unencrypted in a file header or another part of the document 17 such that it is readable without requiring that document 17 be decrypted in order to do so. This indexing information may have been added to document 17 by author system 12, owner 14 or recipients 16 or 19.

While in transit across the Internet, document 17 is encrypted. Each party receiving either blank document 15 or edited document 17 is uniquely identified by the system (this includes author system 12, owner 14, recipients 16 and 19). This unique identification may be a digital signature, or it may be a globally unique identifying number or any other method.

This unique identification is used initially by document origination system 12 to grant specific document-related rights. The association of these rights with unique parties may be implemented by providing a separate decryption password to each party, where each password unlocks a certain combination of rights (these passwords and associated rights assignments may be created by document origination system 21 when it creates blank document 15 initially).

Or, alternatively, this may be implemented by document viewing software resident on author system 12, owner 14, and recipients 16 and 19 each using a digital signature to provide unique identification. Initially, document origination system 21 builds blank document 15 with specific rights associated with certain identities. When an attempt is made to open either blank document 15 or edited document 17, the document viewing software checks a digital certificate to validate a user's identity. Once identity is confirmed, the document viewing software opens the document and allows only those rights the document file itself grants to that specific identity. Recipients 16 and 19 may then view and automatically extract data from document 17 into another system.

By way of example only, recipients 16 and 19 may be mortgage brokers and document 17 may be a financial statement from a bank. Recipients 16 and 19 may each have local document management systems and automated loan processing systems. Data extracted from document 17 can be automatically moved into these systems without requiring manual re-entry. Metadata may be embedded in the document or stored elsewhere in the system which may be used by these systems to correctly identify which fields in the document represent which data. For example, one field may be the current balance of a bank account belonging to owner 14, another field may be the date of the last deposit, etc. Also, certain fields in document 17 may have been marked by author system 12 as hidden or blacked out for certain recipients. As such, recipients 16 and 19 may not be able to access certain fields of document 17 because they were not granted the rights to those fields, even though they were in fact given the overarching right to open the document. It is important to note that rights may be specified in this field-granular fashion corresponding to certain identities.

Referring to FIG. 3, alternatively, the document viewing software may also travel with the transmitted document 17b. In this embodiment, document origination system 21 generates a blank document and then embeds it directly inside of an executable of the document viewing software 15b. The document data itself is highly obfuscated and difficult to extract from the executable program. Executable containing blank document 15 is then sent to author system 12, which has the right to open and edit the contained document. The system then functions as described in the previous example, with the exception that the document viewing software and edited document are fused in the same file and travel together as an executable containing document 17.

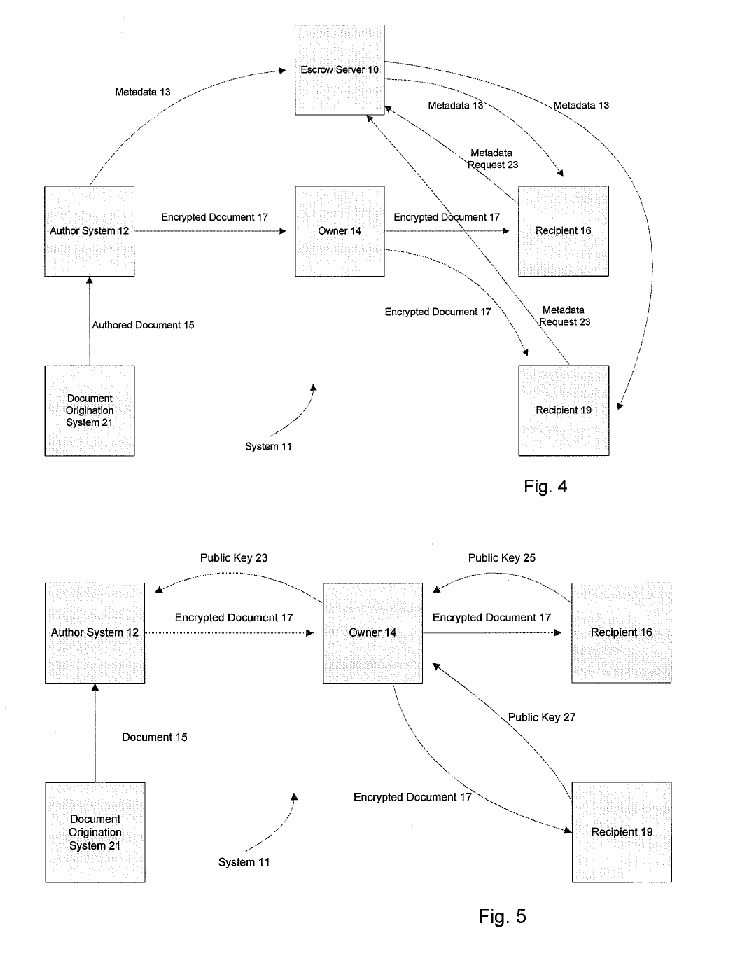

Referring now to FIG. 4, system 11 provides a centralized directory for example, in escrow Server 10 which acts an escrow for all document metadata, access and verification information. The central directory certifies the authenticity of all documents in the system and ensures that they have remained unaltered by intermediaries in transit.

Author system 12 receives document 15 from document origination system 21. Alternatively, document 15 may be scanned into author system 12 from a paper source using OCR or another scanning technology. Author system 12 then may produce a hash table based on the bitwise content of document 15. For example, author system 12 may produce a hash table generated as a function of the value and location of each bit, or other unit of document 15, or some other function. This hash table along with encryption keys, all associated metadata, access and verification information, may then be sent to centralized directory 10 as metadata 13.

Author system 12 sends encrypted document 17 to owner 14. Owner 14 may open and view encrypted document 17 but may not alter it in any way (since in this embodiment, any alteration would invalidate the stored hash table). Owner 14 then sends encrypted document 17 to recipients 16 and 19. Recipients 16 and 19 may then both request metadata 13, containing the decryption keys and other associated information, from centralized directory 10. Upon receipt, they may both open encrypted document 17. Recipients 16 and 19 may then examine the hash table contained in metadata 13 against the bitwise contents of the decrypted file, thus providing them with the ability to detect whether the file was altered in transit or not. Lastly, recipients 16 and 19 may request verification from centralized directory 10 that document 17 indeed originated with author system 12.

Referring now to FIG. 5, system 11 provides an alternative embodiment whereby successive public key encryptions and partial decryptions are daisy-chained together to ensure the authenticity of a document provided to recipients 16 and 19 by author 12, but to which access is still controlled and mediated by owner 14.

Document origination system 21 sends document 15 to author system 12. Author system 12 requests public key 23 belonging to owner 14, and then encrypts document 15 with it. Encrypted document 17 is then sent to owner 14. Owner 14 partially decrypts document 17 with owner 14's private key, which may be related to public key 23, such that it may be viewed, however, the digital signature of author system 12 is left intact and remains embedded in document 17. Owner 14 then requests public keys 25 and 27 belonging to recipients 16 and 19. Owner 14 then re-encrypts the document with public keys 25 and 27 respectively, and sends the corresponding re-encrypted document to recipients 16 and 19 respectively. Recipients 16 and 19 may then each decrypt and view original document 17 with their own private keys. Since the digital signature belonging to author system 12 remains intact, recipients 16 and 19 can authenticate that author system 12 is indeed the originator of document 17 and that it has remained unaltered in transit by owner 14 or any another party.

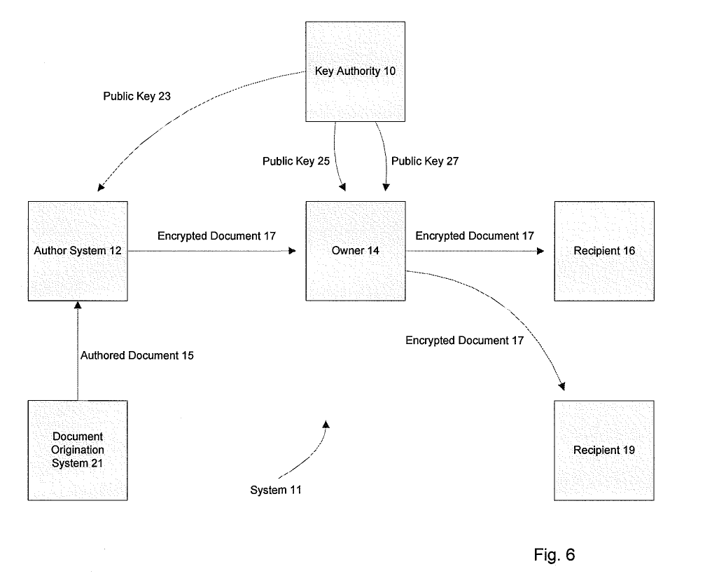

Referring now to FIG. 6, system 11 provides an alternative embodiment where key authority 10 provides a central lookup repository of public keys for every entity in the system. Author 12 obtains public key 23 belonging to owner 14 from key authority 10 and encrypts document 15. Encrypted document 17 is then sent to owner 14, who then partially decrypts document 17 with its private key such that it may be viewed, however, the digital signature of author system 12 is left intact and embedded in document 17. Owner 14 then obtains public keys 25 and 27 belonging respectively to recipients 16 and 19 from key authority 10. Owner 14 then re-encrypts the document with each respectively, and sends the corresponding document to each. Recipients 16 and 19 may then each decrypt and view document 17 with their own private keys. Since author system 12's digital signature remains intact, recipients 16 and 19 can authenticate that author system 12 is indeed the originator of document 17 and that it has remained unaltered in transit by owner 14 or another party.

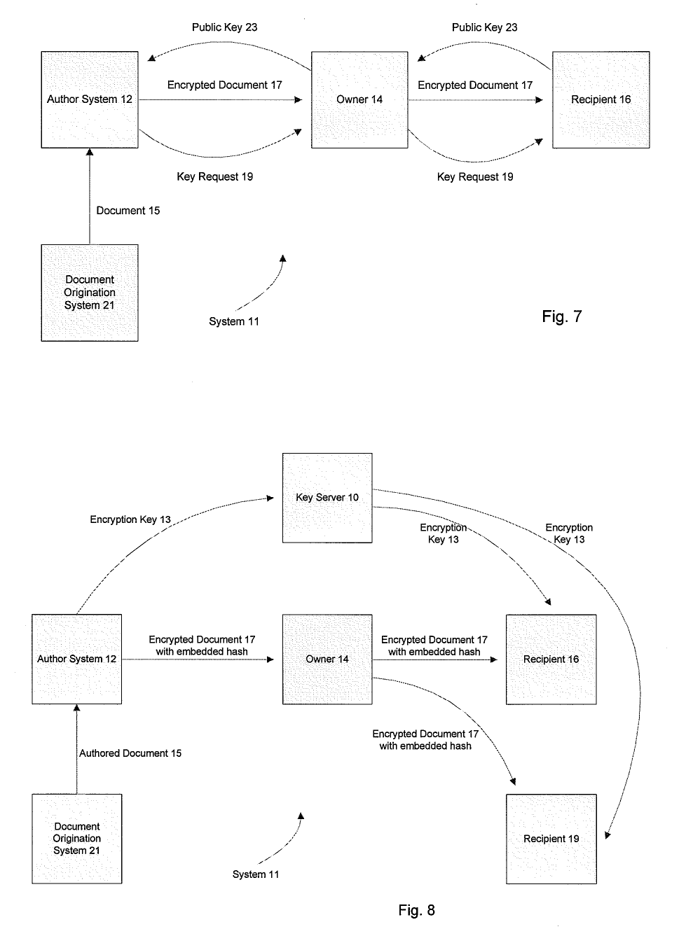

Referring now to FIG. 7, system 11 provides an alternative embodiment whereby author 12 encrypts a document 15 with recipient 16's public key directly. In this embodiment, owner 14 may not open or view encrypted document 17 but owner 14 is still in control of which recipients (if any) have access to document 17.

In particular, author system 12 sends key request 30 to owner 14, asking for the public key of the recipient 16 to whom owner 14 intends to forward document 17. Owner 14 in turn forwards key request 30 to recipient 16. Recipient 16 provides their public key 23 to owner 14, who in turn forwards it to author 12. Author 12 then encrypts document 15 with public key 23 and sends encrypted document 17 to owner 14. Owner 14 is not able to open or view encrypted document 17, but owner 14 at this point has total control over the forwarding of copies of encrypted document 17. Owner 14 may, for example, forward encrypted document 17 to recipient 16, who is able to decrypt and open the document because it was encrypted with recipient 16's own public key. If owner 14 wishes to forward encrypted document 17 to any further recipients, such as recipient 19, recipient 19's public key must be made available to author system 12 for encryption of document 17 and encrypted document 17 must be forwarded to recipient 19.

It is important to note that the previous three embodiments provide the capability for owner 14 to act as a gatekeeper in deciding which recipients (if any) receive a copy of encrypted document 17. This provides persistent control over document 17 to owner 14, since the security mechanisms exist at the document-level, not the system-level. It also important to distinguish that because the system is distributed in this fashion with document-level security, there is no central authority or system administrator that can override the security measures and gain unauthorized access to document 17. Furthermore, recipients are able to authenticate that author 12 is indeed the originating entity through a digital signature and that encrypted document 17 has not been altered by owner 14 or any other intermediary.

Referring now to FIG. 8, system 11 provides an alternate embodiment for allowing owner 14 to control the access rights to encrypted document 17 by recipients 16 and 19, while ensuring that encrypted document 17 has not been tampered with by owner 14 or any another intermediary.

Author system 12 receives document 15 from document origination system 21. Author system 15 then may produce a hash table based on the bitwise content of document 15. For example, author system 15 may produce a hash table generated as a function of the value and location of each bit, or other unit of document 15, or some other function. This hash table may then be embedded directly in document 15 which is then also encrypted, creating encrypted document 17. The encryption keys 13 for encrypted document 17 may be deposited with key server 10.

Author system 12 sends encrypted document 17 to owner 14. Owner 14 may open and view encrypted document 17 but may not alter it in any way (since in this embodiment, any alteration would invalidate the hash table). Owner 14 then sends encrypted document 17 to recipients 16 and 19. Recipients 16 and 19 may both open encrypted document 17 and examine the embedded hash table against the bitwise contents of the decrypted file, thus providing them with the ability to detect whether the file was altered in transit or not.

Alternatively, the hash table may be stored by author system 12 with key server 10 rather than embedded directly in the file. When recipients 16 and 19 decrypt encrypted document 17, they may request the hash table from key server 10 and then compare it against the bitwise contents of the decrypted file, revealing whether the file has been altered in transit. Alternately, recipients 16 or 19 could forward or create a hash table related to encrypted document 17 and request that the hash table be confirmed by key server 10.

In an alternate embodiment, a full copy of encrypted document 17 may also be stored in key server 10 for use as a standard of comparison, e.g. as a ‘gold standard’. When recipients 16 and 19 receive encrypted document 17, it may be compared with the gold standard stored in key server 10 on a bitwise basis to determine whether it is the same file. Alternatively, random bit compares may be performed between the gold standard and encrypted document 17.

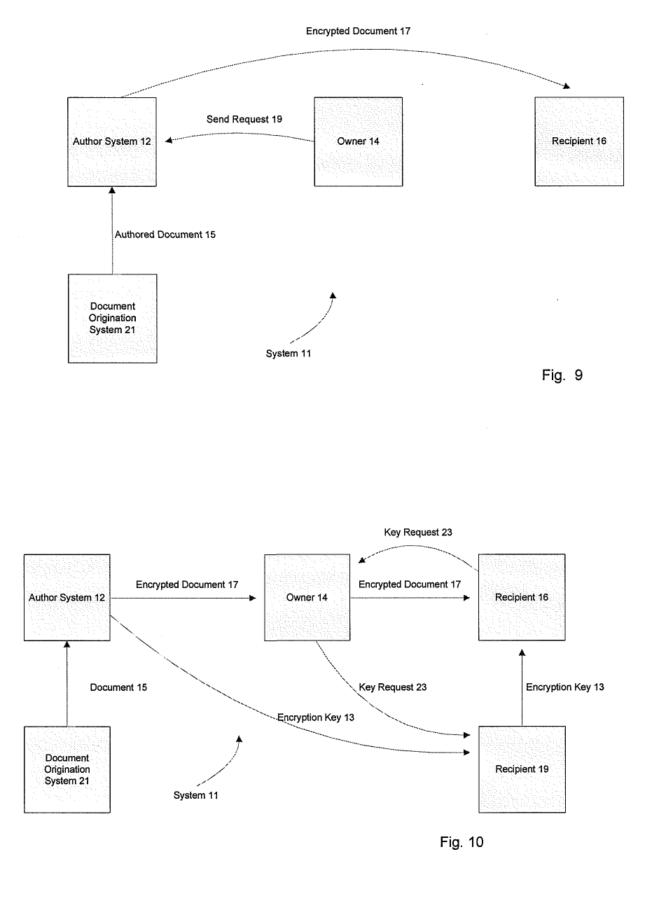

Referring now to FIG. 9, system 11 provides an alternative embodiment where recipients 16 and 19 receive encrypted document 17 directly after owner 14 grants permission for such a transfer to occur.

Document origination system 21 sends document 15 to author system 12. Owner 14 then may initiate a request to author system 12 to send encrypted document 17 to recipient 16, or recipient 16 may initiate the request to author system 12, or author system 12 may push document 17 to recipient 16. Author system 12 may obtain recipient 16's public key directly from recipient 16, or from a central directory, or in any other way. Author system 12 may then encrypt document 15 with the public key belonging to recipient 16, creating encrypted document 17. Encrypted document 17 is then sent by author system 12 directly to recipient 16, who is then able to decrypt and open it.

In this embodiment, owner 14 still controls which recipients (if any) are granted access to encrypted document 17 because author system 12 only provides documents, owned or controlled by owner 14, to third party recipients at owner 14's specific request.

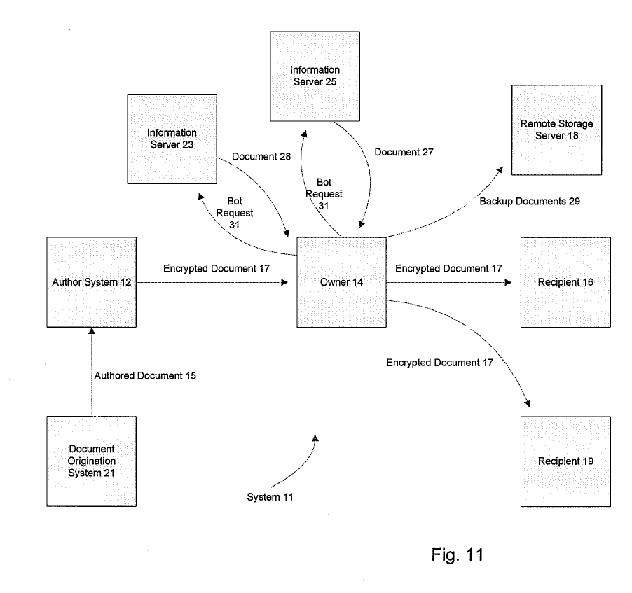

Referring now to FIG. 10, system 11 provides for an alternate embodiment where the key server is distributed rather than centralized. In this embodiment, the mechanisms of the key server may be present on all or some of the software used throughout the system. Specifically, author system 12, owner 14, and recipients 16 and 19 may each have peer software working in synchronization to provide the capability of authorizing keys in a distributed fashion. Each peer may have a local obfuscated file system for storing keys used throughout the entire system that is extremely difficult for a user to read as a raw data file. Each local obfuscated file system may contain a piece of the overall key server file system (or a copy of the entire file system) and contain references to other pieces of the key server file system that are located on other peer machines in the network (and the current location of all other peers). Each peer may query one or more other peers for pieces that it does not directly possesses, following a chain of peers until the query arrives at the peer containing the information or confirmation that it does not exist. The query result would then travel back through the same path of peers until reaching the peer that originated the request.

For example, when encrypted document 17 was first created, the distributed key server may have selected the peer software running on recipient 19 to store encryption key 13. It is important to note that since the key server data is distributed, there is no reason why recipient 19 in particular is chosen to store encryption key 13. The key may have been located with owner 14, or half of the key may have been stored with owner 14 and the other half with author 12, or any other combination of locations or apportioning of the data.

By way of example only, if recipient 16 seeks the keys to open encrypted document 17, recipient 16 would initiate key request 23 to adjacent peers in the network, which may include owner 14. Owner 14 looks in its local key server peer file system and discovers that it does not possess the requested key, and subsequently passes key request 23 along to other network adjacent peers which may include recipient 19. Recipient 19 looks in its local key server peer file system and discovers it does indeed have encryption key 13 to document 17. Recipient 19 may then pass encryption key 13 to the original requesting entity, recipient 16, who is now able to decrypt and open encrypted document 17.

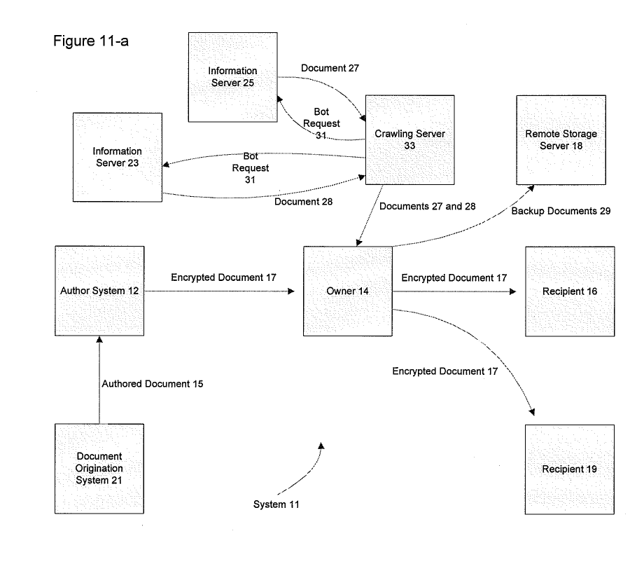

Referring now to FIG. 11, system 11 provides a mechanism whereby owner 14 is able to automatically crawl a number of information servers to acquire relevant documents in addition to receiving documents passively. This system provides a way to manage, store and index documents, data, and metadata from multiple sources as well as manage the delivery of these items to multiple recipients from a single interface.

Owner 14 may receive encrypted document 17 from author system 12 as in the previous embodiments. Owner 14 may also have targeted crawler software which routinely retrieves information on the Internet from relevant locations. For example, owner 14 may have accounts at several financial institutions that provide online banking, and may find it useful to periodically download the most recent copy of a financial statement document. Owner 14 may crawl and obtain documents 27 and 28 from information servers 21 and 23. Alternatively, owner 14 may download or scrape information contained in documents 27 and 28, but not the documents themselves, and build local documents reflecting this information. By way of example only, this functionality is useful for the automatic gathering of documents or data for tax preparation or for a loan application.

Once the relevant documents and/or information have been acquired by owner 14, they may be filed locally using metadata contained in the document or associated with the document by document type. Alternatively, the document or information acquired by owner 14 may be scanned and a ‘best guess’ as to document type may be ascertained and filing may then occur based on this assessment. For example, owner 14 may acquire banking statements, trading statements, W-2's, 1099's, or other documents or information, and crawler software would then organize the files locally by the kind of document each is.

This resultant file system of documents, metadata and data controlled by owner 14 is now highly structured content. It may be searched or sorted by date, document type, internal fields and data, full text, information about owner, information about recipient, information about source, or any other criteria or combination of criteria or queries. The file system may provide version control and may provide the ability to step back to previous versions of a particular document. It may provide for differences between versions of a particular file to be accessed or compared or manipulated in any other way. It may combine multiple documents. It may provide a folder file structure which can be browsed, or it may provide a tag cloud, or it may provide any other metaphor or visualization of the documents, data and metadata it contains. All of these indexes can be updated.

The structured content in the file system controlled by owner 14 may contain documents in formats such as plain XML, OFX XML, IRS XML, MISMO XML or any other format. The file system may provide translators between these different standards and formats, making every possible translation of any document in the system available to owner 14 and multiple recipients.

Information servers 21 and 23 may be registered participants in the system or they may be passive participants. Bot or automated request 31 may be sent from owner 14 to information servers 21 and 23. Bot request 31 may be in the form of an automated login and information scrape process over standard http, or any other protocol. Information 21 and 23 are then either scraped for documents or document information or they are made to send it to owner 14. By way of example only, documents 28 and 27 are then acquired from information servers 21 and 23 respectively.

In the case where information servers 21 and 23 are registered participants, each may digitally sign and encrypt documents 27 and 28 sent to owner 14 such that owner 14 acts as an intermediary controlling access to documents 27 and 28, yet still validating that information servers 23 and 21 respectively are the original authors. This may ensure that the information in documents 27 and 28 have not been tampered with using any of the methods described in previous embodiments or using another method. Owner 14 may then forward the relevant documents to recipients 16 and 19.

By way of example only, a financial institution would typically know a customer's name, his or her social security number, the account number, the type of account (for example checking, saving, brokerage, mutual fund), relevant dates (for example the date the document was created, downloaded, the tax year for the document) for a particular document, the type of institution the author is (for example banking, brokerage, insurance, accountant), the type of document (for example a monthly statement, a 1099, a 1098, an annual report, a prospectus) it is sending (or that the customer is acquiring via a crawler).

The disclosed system would allow the author to associate that metadata to either documents received digital or scanned from a physical document using a standardized format and language. The owner's and Document Recipient's software programs would be able to identify that information and use it to automatically organize, file, index, sort, retrieve, copy, forward each particular document according to its metadata.

Owner 14 may archive and backup these documents locally or may periodically perform a dump of backup documents 29 to remote storage server 18, where the data may be warehoused.

Referring now to FIG. 11-a, alternatively, owner 14 may receive documents 27 and 28 through a server assisted method as opposed to directly acquiring them. In this embodiment, owner 14 may connect to crawling server 33 which performs the actual crawling of information servers 21 and 23, thus obtaining documents 27 and 28 or the information contained in them, and passes them back to owner 14. Information servers 21 and 23 may alternatively send documents 27 and 28 to crawling server 33 proactively or triggered through a request or any other event in the system. Crawling server 33 may be able to obtain fully-formed authenticated and encrypted documents from information servers 21 and 23, or it may be limited to data scraping web pages found on those servers for the necessary information, or obtaining full or partial information in some other way.

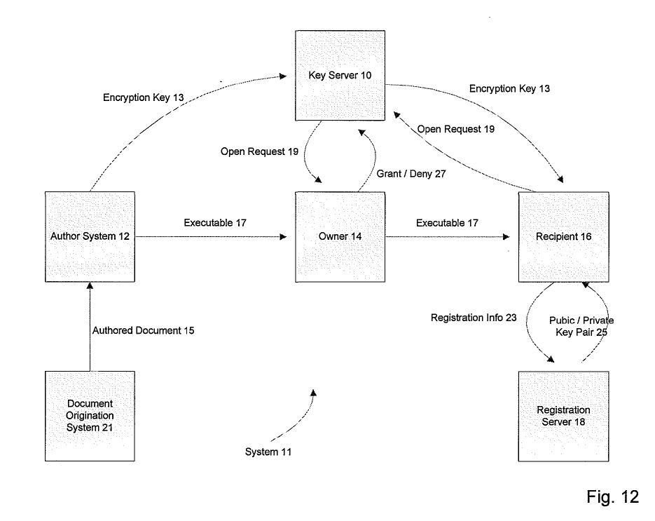

Referring now to FIG. 12, system 11 provides a method for Owner 14 to send an encrypted document to an unknown recipient and have that recipient be able to open and view that encrypted document. This same process would also apply if a recipient had an unknown or unrecognized public key.

Document origination system 21 sends document 15 to author system 12. Author system 12 then encrypts document 15 and wraps the encrypted document in executable document reader software, while the encryption key 13 is escrowed with key server 10. It is important to realize that anyone possessing encryption key 13 could open the document, not just an intended recipient. Executable-wrapped document 17 is sent to owner 14, who in turn sends it to recipient 16. If and only if recipient 16 is already a registered user of the system, then recipient 16 is able to open executable-wrapped document 17 by requesting the encryption key 13 from key server 10. However, if recipient 16 is not a registered user of the system, and runs executable-wrapped document 17, recipient 16 is informed that they must first register with the system and executable-wrapped document 17 may provide a registration form for them to do so directly in the software. Once this form is completed, registration information 23 may be sent by the executable program to registration server 18. (It may alternatively open a web page that resides on registration server 18, or registration may occur in another way.) Once the registration is complete, registration server 18 distributes a newly-generated public/private key pair 25 to recipient 16. Alternatively, the executable may generate a public/private key pair locally and inform registration server 18 of what these are. Recipient 16 then uses this new public key identity to request the decryption keys to executable-wrapped document 17 from key server 10 by sending open request 19. Key server 10 then forwards open request 19 to owner 14, asking permission to grant the key to recipient 16. Alternatively, owner 14 may have pre-granted this permission and registered this with key server 10. Once owner 14 grants or denies permission, grant/deny permission 27 may be sent to key server 10. If permission has been granted, key server 10 delivers encryption key 13 to recipient 16 who is now able to unlock the information contained in executable-wrapped document 17.

Alternatively, the same process may be used to initiate owner 14 into the system if owner 14 had not previously registered and obtained a public/private key pair, or if owner 14 had an unknown or unrecognized public key. The process is identical, except that author system 12 would now function as the entity granting permission to owner 14 to open document 17 and there would be no intermediary passing document 17 along as author system 12 would send it directly to owner 14.

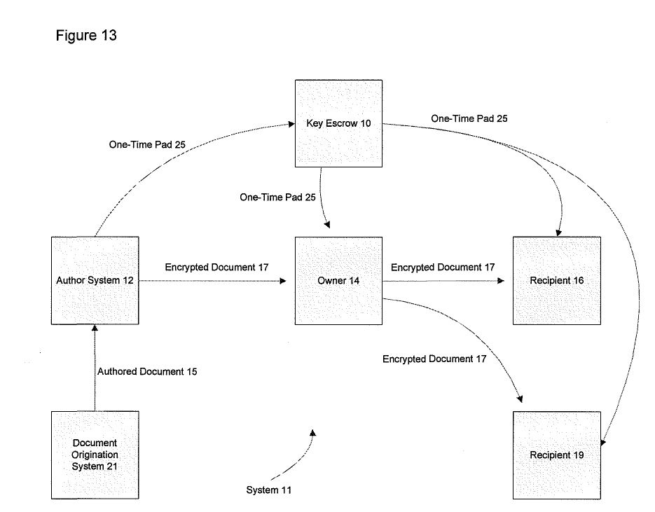

Referring now to FIG. 13, system 11 provides an alternative embodiment where one-time pads are used as the primary encryption mechanism between participants in the system.

Document origination system 21 sends document 15 to author system 12. Author system 12 then encrypts document 15 with one-time pad 25, resulting in encrypted document 17. Author system 12 may then deposit one-time pad 25 with key server 10 and send encrypted document 17 to owner 14.

Owner 14 may then request one-time pad 25 from key server 10. Key server 10 may then supply one-time pad 25 to owner 14, who may now decrypt and open encrypted document 17. Alternatively, key server 10 may decide not to grant permission to owner 14 to prevent tampering with encrypted document 17 and ensure the authenticity of author system 12 as the source. This option still allows owner 14 to mediate who receives a copy of encrypted document 17, but owner 14 may not open or view the document.

It is important to realize that in this embodiment if key server 10 does grant one-time pad 25 to owner 14, owner 14 may freely alter the decrypted version of encrypted document 17 and use one-time pad 25 to re-encrypt it and pass it off to recipients 16 and 19 as the original document 17. It is also not possible to assign certain document permissions to certain users in the system based on confirmed identification or field-level permissions using the one-time pad method as the encryption mechanism. However, one-time pad encrypted document 17 may encapsulate an executable or other intelligent document or some other method to enforce field-granular permissions and to ensure the identity authenticity of author system 12 as the source. The one-time pad encryption mechanism may be used solely to obfuscate document 17 in transit, and the system may rely on other mechanisms within or without to accomplish its other functions.

Owner 14 may then forward encrypted document 17 to recipients 16 and 19, who in turn may request one-time pad 25 from key server 10. Once granted, recipients 16 and 19 may then open encrypted document 17. If owner 14 was not granted one-time pad 25, recipients 16 and 19 can verify that author 12 was indeed the source of document 17 and that it has not been tampered with or altered in transit.

Alternatively, every participant in the system may already have a local copy of a large number of pads. Encrypted document 17 may identify which one-time pad in particular it was encoded with by author system 12 (this may be a serial number or some other identifier) in a clear text header or in some other fashion, allowing owner 14 and recipients 16 and 19 to decrypt it by looking up the corresponding one-time pad locally and applying it to decrypt document 17. Alternatively, all one-time pads may be managed by key server 10 and distributed on request to participants in the system based on the serial number of the one-time pad or some other identifier.

Referring now to FIGS. 1-13, there are six primary attributes or functions provided by many if not all the preferred embodiments. One attribute of the present method and system is that the document can be viewed by the Owner. This aspect distinguishes the system from data only systems in which people can not view the information in a legible format until it reaches the final destination and then the data is often displayed in the native format of the destination system rather than the source system.

Another attribute is that the present method and system may provide automatic distribution of the documents via email or automatic searches of one or more websites. Automated online backup may then also be performed.

Another important aspect is that the present method and system may provide document level metadata or add-on data. A party other than the Source may have persistent document metadata control. For convenience, the core or most important metadata or add-on data may be of a type or stand known by multiple Sources and useful to multiple Owners and/or multiple Data Users. The metadata may be attached by the Source for use by Owner and Data Users. Metadata may be standardized across multiple Sources, Owners, and Data Users and core Document metadata may be configured to not be customizable. Source data, such as by name of the source and the type of institution, together with date data, allows simple filing cabinet organization. Document metadata, for example, tax document number, SEC number or other formal document numbering may more conveniently permit systematic gathering, organizing, storage, and retrieval of different types of Documents from multiple Sources. As an example, income data for a potential borrower may be gathered from an accountant, asset data may be borrowed from a broker and the like for the purpose of processing a mortgage application.

Field level metadata, for example in XML format, provides another important attribute. Field level metadata may be persistently controlled by a party other than the Source. It may be attached by the Source for use by the Owner and other data users or recipients and allows information from multiple Sources to be combined.

Another important aspect of the method and systems disclosed herein is privacy. Privacy may be persistently controlled by the Owner rather than by the Source of the data including along a direct or indirect path including multiple intermediate parties. The Source may designate the Owner of the Document. Any System Administrators, or similar supervisor parties cannot see the encrypted data because encryption keys follow different paths than followed by the documents.

Another important aspect is that security is added by the Source but the security is independent of any particular Source or enterprise (i.e. the Owner does not need access to the rights management system controlled by any particular Source or enterprise to benefit from the disclosed techniques.

Registration information about Owners and Data Users may be shared by multiple Sources, i.e. an encrypted document can be sent to someone who either 1) does not have a public/private key when the Document is sent, or 2) the sender does not know what the key is. Similarly, unlike conventional techniques, the Source does not need to know who the final recipient is going to be. This enhances the ability of the data owner to control the data despite the involvement of multiple Sources.

Authentication is another important aspect. A party other than the Source has persistent authentication control. This permits Source authentication and validation despite Document being in possession of the Owner, i.e. documents become self authenticating documents because recipients do not need to go back to Source to authenticate the documents. Because the system may have hundreds of possible Sources that are unknown to the final recipient, the system may provide a non-encrypted indication of who the “probable” Source is so that the appropriate public key can be looked up easily. This allows blocking of parts of the data within the document while retaining authentication of the source and content of the document. Registration information about Owners and Data Users may be shared by multiple Sources and data can be extracted from the document, and/or the document can be viewed, without losing authentication. This provides a single place and process for Owners and Data Users for authentication despite the existence of multiple Sources.

Other attributes include the use of encryption envelopes which provide affirmative control regardless of the current location of the document. As a result, system administrators do not need to know where the document is in order to control rights management. Another way to look at this aspect, is that the system works by each document knowing the location of the central server—rather than the central server tracking the location of each Document. Further, the bundle of rights to any particular document can be broken up and different rights can be controlled by entities. The Source of the document typically determines which entity has control over which portion of the bundle of possible rights to the data in the document.

There are various possible combinations of the various attributes involving privacy that can be used in different embodiments:
Document metadata with the Owner controlling privacy from the Owner to the Data Users
Document metadata with Owner controlling privacy from the Source to a Data User that is unknown to the Source
Owner controls privacy from Source to Owner with persistent privacy
Owner controls privacy from Source to Owner with self authenticating Documents
Owner controls privacy from Owner to Data User with Owner controls privacy from Source directly to Data User
Owner controls privacy from Owner to Data User with persistent privacy
Owner controls privacy from Owner to Data User with XML
Owner controls privacy from Owner to Data User with any form of authentication
Owner controls privacy from Owner to Data User with auto distribution
Owner controls privacy from Source to Data User with persistent privacy
Owner controls privacy from Source to Data User with XML
Owner controls privacy from Source to Data User with auto distribution
Owner controls privacy from Source directly to Data User with document level privacy control (not account level)
Persistent privacy with auto distribution
1. Other possible combinations include:
   Auto distribution of Documents with Document metadata
   Auto distribution of Documents with XML
   Auto distribution with authentication
   Document metadata with XML
   Document metadata with authentication
   XML with Authentication.

I claim:

1. A method of providing financial documents, comprising:
obtaining an encrypted financial document related to a financial services user from a source of financial services;
forwarding, to a escrow key server, one or more encryption keys for decrypting the encrypted financial document;
facilitating the transfer of the encrypted financial document to a financial document user as authorized by the financial service user; and
transferring a copy of the one or more encryption keys from the escrow key server to the financial document user as authorized by the financial service user so that the financial document user can decrypt the encrypted financial document as an authenticated document unchanged from when it was obtained from the source of financial services.

2. The method of claim 1 wherein facilitating the transfer of the encrypted document to the financial document user further comprises:
receiving a request for the encrypted document at the escrow key server from the financial document user;
obtaining approval from the financial services user to transfer the encrypted financial document to the financial document user; and then
transferring the encrypted financial document to the financial document user.

3. The method of claim 2 wherein the encrypted document and one or more encryption keys are transferred together to the financial document user.

4. The method of claim 1 wherein facilitating the transfer of the encrypted document to the financial document user further comprises:
receiving authorization from the financial services user for the key escrow server to transfer the encrypted financial document to the financial document user upon request; and
forwarding the encrypted financial document from the escrow key server to the financial document user upon receipt of a request therefore from the financial document user.

5. The method of claim 1 further comprising:
forwarding a copy of the encrypted financial document to the financial services user.
